(19) United States
(12) Patent Application Publication
(10) Pub. No.: US 2019/0143927 A1
(43) Pub. Date: May 16, 2019

(54) GAS BAG UNIT AND VEHICLE PASSENGER SAFETY SYSTEM HAVING SUCH A GAS BAG UNIT, AND MANUFACTURED METHOD

(71) Applicants: Jacobo Casal Alonso, Balona (ES); Ruben Barros Alonso, Vigo (ES)

(72) Inventors: Jacobo Casal Alonso, Balona (ES); Ruben Barros Alonso, Vigo (ES)

(21) Appl. No.: 16/092,299

(22) PCT Filed: Apr. 21, 2017
(86) PCT No.: PCT/EP2017/059478

§ 371 Date: Oct. 9, 2018

(51) Int. Cl. B60R 21/203

(52) U.S. Cl. CPC B60R 21/2037; B60R 21/261

(57) ABSTRACT

The invention relates to an airbag unit comprising at least one damping element (10), an inflator (20) and a module mounting (30), wherein the damping element (10) is interposed between the inflator (20) and the module mounting (30). Furthermore, the at least one damping element (10) includes at least one engaging means (11) and the inflator (20) includes at least one receiving means (21) so that the damping element (10) and the inflator (20) can be positively connected to each other. The invention further relates to a steering wheel, a vehicle occupant safety system as well as a manufacturing method.

### RELATED APPLICATIONS

This application corresponds to PCT/EP2017/059478, filed Apr. 21, 2017, which claims the benefit of German Application No. 10 2016 005 020.9, filed Apr. 26, 2016, the subject matter of which are incorporated herein by reference in their entirety.

### BACKGROUND OF THE INVENTION

The invention relates to an airbag unit according to the preamble of claim 1 and a vehicle occupant safety system comprising such airbag unit. Furthermore the invention deals with a method of manufacturing such airbag unit. An airbag unit of the afore-mentioned type is known, for example, from DE 10 2007 049 234 B4.

DE 10 2007 049 234 B4 describes an airbag module for a vehicle, inter alia comprising a module mounting, comprising an inflator and at least one elastic damping element. The damping elements are arranged on a vibration damper. The inflator is fastened to the damping elements by hollow rivets. Hence a plurality of different components is necessary to interconnect the components of the airbag module. This requires additional steps in manufacture and results in increased production costs, especially in mass production.

EP 0 983 914 A1 discloses an airbag module comprising a cup-shaped inflator, an airbag and an airbag retaining sheet, the inflator being fastened to an inflator carrier. The casing of the inflator is configured so as to be connected to the airbag module by means of a bayonet or snap-in connection. For this purpose, specific hooks are provided on an additional cylindrical rim of the airbag retaining sheet. The hooks increase the material expenditure during manufacture and allow for different orientations of the casing relative to the airbag module, which may result in manufacturing faults. Moreover, vibrations can be directly transmitted between the airbag module and the inflator.

### SUMMARY OF THE INVENTION

It is the object of the invention to provide an easily manageable and inexpensive option of connecting the components of an airbag unit, especially the inflator, the damping element and the module mounting. Furthermore, it is the object of the invention to state such airbag unit and a vehicle occupant safety system comprising such connecting mechanism as well as a suited manufacturing method.

In accordance with the invention, this object is achieved with respect to an airbag unit by the subject matter of claim 1, with respect to the vehicle occupant safety system by the subject matter of claim 8 and with respect to the manufacturing method by the subject matter of the claims 9 and 10.

For achieving the object mentioned in the beginning the invention provides especially an airbag unit comprising at least one damping element, an inflator and a module mounting. The damping element is interposed between the inflator and the module mounting. Furthermore, the at least one damping element includes at least one engaging means and the inflator includes at least one receiving means. The damping element and the inflator can be positively connected to each other, preferably in the form of a bayonet lock. In this way the components of the airbag unit can be connected in a simple and inexpensive manner without additional connecting elements and working steps being required.

The damping element is advantageously arranged between the inflator and the module mounting. In this way the damping element may prevent the transmission of vibrations between the inflator and the module mounting by (vibration-dynamic) decoupling. The inflator has no direct connection to the module mounting.

Preferably the at least one damping element can be manufactured of an elastic material or an elastic material combination, respectively. Especially the damping element may include an elastomer or comparable material. Thus the damping element may absorb mechanical vibrations. By arranging the damping element between the module mounting and the inflator the components are decoupled in a vibration-dynamic way.

Of advantage, the damping element includes at least one engaging means and the inflator includes at least one receiving means. The damping element and the inflator are positively connectable to each other. The positive connection between the damping element and the inflator may be configured as a bayonet lock. In this way it is possible to easily connect the damping element and the inflator in a quick and safe manner.

Moreover, the damping element may be configured as an individual part or as plural parts adapted to be composed. In particular, a first part on the module mounting side and a second part on the inflator side may be provided. The parts of the damping element may be designed in different functional ways. Preferably geometric connecting elements such as the at least one engaging means can be arranged on either of the two parts. The parts of the damping element may be manufactured or adapted to be manufactured of different materials. In this way, specific functionalities of the damping element may be provided.

In a preferred embodiment of the invention the damping element is preferably configured as an annular damping element of L-shaped cross-section. In this configuration, the damping element is advantageously designed to receive an inflator and to support the inflator all around its rim by means of the L-shaped cross-section. When connecting the inflator to the damping element, vibration-dynamic damping of the inflator is thus ensured.

In another embodiment of the subject matter according to the invention the engaging means is arranged on an inner side, preferably an inner diameter, of the damping element. If the inflator is attached to the preferably L-shaped cross-section of the annular damping element, the engaging means of the damping element is designed to engage behind the inflator and, respectively, the rim thereof. This means that the rim of the inflator is interposed between a bearing face of the damping element and the engaging means of the damping element. This allows realizing a positive connection between the damping element and the inflator, inter alia in the preferred form of a bayonet lock.

According to the present invention, the inflator is formed in an embodiment comprising a receiving means as at least one material cutout. The at least one material cutout is arranged especially on a rim of the inflator. Advantageously, the at least one material cutout has a shape corresponding to the engaging means of the damping element. The inflator and the damping element can be attached onto each other along the material cutouts and the engaging means so that the engaging means of the damping element are adapted to engage behind the rim of the inflator. This ensures the manufacture of a safe positive connection between the inflator and the damping element.

This connection may be additionally supported by tensioning elements provided on the damping element. The tensioning elements apply pre-tension to the connection between the inflator and the damping element so that the connection is prevented from automatically releasing. In this case the positive connection between the inflator and the damping element in accordance with the present invention can also be understood to be a positive and frictional connection.

Furthermore, the damping element according to an embodiment of the present invention includes an aligning means so that the inflator and the module mounting can be aligned with each other. The assembly of the damping element and the inflator is facilitated by the aligning means in so far that, after attaching the two components onto each other, the correct alignment of the components with each other is predetermined by the configuration of the components so as to establish a positive connection. This enables assembly within very short time.

Moreover, the aligning means of the subject matter according to the invention preferably includes an extension on the module mounting side and an extension on the inflator side. Each of the module mounting side and, resp., inflator side of the damping element describes the side of the damping element which faces the module mounting and, resp., the inflator in the mounted state of the airbag unit according to the invention.

Accordingly, the aligning means is configured so that it exhibits a material extension both in the direction of the module mounting and in the direction of the inflator. Thus the aligning means of the damping element is in functional interaction both with the inflator and with the module mounting so as to ensure the correct relative alignment of the inflator, the damping element and the module mounting of the airbag unit.

In another advantageous embodiment of the present invention the aligning means is flexibly and, resp., resiliently supported in the direction of the module mounting side and in the direction of the inflator side. When connecting the inflator, the damping element and the module mounting, the flexibly and resiliently supported aligning means thus fulfills the function of assisting the correct appropriate component alignment and, at the same time, of preventing faulty component alignment during assembly. This is especially enabled by deflecting the aligning means toward the module mounting or toward the inflator.

In accordance with the present invention, by the flexible and resilient support of the aligning means also the support with the help of further mechanical elements, such as springs, or the combination of different materials for achieving specific rigidities has to be understood. Of preference, the flexible support of the aligning means is provided as a beam supported on one side having a specific rigidity and, resp., flexibility. For this purpose, the aligning means may be surrounded by a U-shaped through-groove or through-hole. The through-groove extends through the damping element along the basis of the aligning means. The bearing force of the resiliently supported aligning means may be generated by adaptation of the shape of the through-groove and, accordingly, is variably adjustable.

In accordance with a preferred embodiment of the airbag unit according to the invention, the inflator, especially the rim of the inflator, includes a through-hole, preferably in a shape corresponding to the aligning means. The through-hole allows receiving the aligning means. If the damping element is positively connected to the inflator, the aligning means serves for correctly aligning the components, preventing faulty alignment and positively fixing the connection and, resp., aligning the components. Hence safe connection of the damping element and the inflator is ensured.

With the aligning means a so called “poka yoke” mechanism is integrated in the damping element. The “poka yoke” mechanism is based on the principle of taking one or more technical measures to reveal and/or prevent faults. Such measures may be taken, for example, by providing interacting connecting means or individual elements for setting specific component alignments in the design of the individual components.

This is applicable, in the case of the present invention, especially to the relative arrangement of the individual components during assembly of the airbag unit. By integrating the connecting means in the design of the damping element it is not necessary to employ any further connecting elements or connecting means apart from the components of the airbag unit according to the invention. In this way a simple inexpensive and time-optimized manufacture of the airbag unit is achieved.

It may further be provided in the present invention that a through-hole for receiving the aligning means is formed on the module mounting. The through-hole of the module mounting preferably takes a shape corresponding to the aligning means, especially to the extension of the aligning means on the module mounting side. The aligning means may engage both in the through-hole of the inflator and in the through-hole of the module mounting. The alignment of the three components relative to each other is thus predetermined and at the same time safeguarded at least in the rotational direction so as to allow for an as simple and safe assembly of the airbag unit according to the invention as possible.

Furthermore, at least one detent foot may be configured on the damping element according to the present invention so that, when the aligning means engages in the through-hole of the module mounting, the damping element is connectable to the module mounting via the at least one detent foot. The through-holes of both the module mounting and the inflator may take shapes corresponding to the aligning means or alternatively larger geometries.

For receiving the at least one detent foot preferably at least one detent aperture is provided in the module mounting. Only when the inflator, the damping element and the module mounting are correctly positioned relative to each other, can the aligning means be received in the through-holes of the inflator and of the module mounting and can the detent foot of the damping element be locked within the module mounting. Advantageously, the alignment of the components thus is additionally ensured by receiving the detent foot within the module mounting.

The integral design of the damping element allows for complete decoupling of the inflator from the module mounting. The connecting elements for assembling the inflator, the damping element and the module mounting are provided (with the aid of an integral design) directly inside the damping element. Corresponding elements are provided in the adjacent inflator and in the module mounting. Preferably there is thus no direct connection between the inflator and the module mounting. The inflator and the module mounting may be aligned relative to each other via the damping element and can thus be secured or locked, resp., in the rotational as well as translational direction. The individual components may be directly fastened to each other. This enables serial assembly of the components, e.g. on a production line, in particular because the components of the airbag unit mutually retain each other.

Apart from the airbag unit according to the invention, independent aspects of the present invention relate to a steering wheel comprising said airbag unit as well as a vehicle occupant safety system comprising a steering wheel and/or an airbag unit according to the invention.

The present invention further comprises a method of manufacturing an airbag unit according to the invention. It is especially provided that, after the damping element engages with the engaging means in the receiving means of the inflator, the damping element and the inflator are twisted against each other along a joint axis of rotation so that a positive connection is established. Said positive connection preferably corresponds to a bayonet lock.

When the damping element and the inflator are arranged on top of each other, preferably along the at least one engaging means and the at least one receiving means, the engaging means may engage behind the rim of the inflator. The engaging means and the receiving means are twisted against each other by a rotational movement and are no longer provided to be superimposed. Hence a positive connection is resulting from the engaging means engaging behind the rim of the inflator.

In another embodiment of the method according to the invention it is provided that the flexibly supported aligning means is arranged on the damping element and each of the at least one corresponding through-hole is arranged on the inflator and on the module mounting so that the inflator and the module mounting are positioned relative to each other, when the aligning means engages in the corresponding through-holes. Complete engagement of the aligning means in the through-holes indicates correct alignment of the components. Simultaneously, the aligning means of the damping element prevents the components from being twisted relative to each other upon engagement in the through-holes of the inflator and of the module mounting. Thus the aligning means is adapted to both align and verify a correct and complete assembly of the airbag unit.

The method according to the invention further provides in an advantageous configuration that the at least one detent foot and the aligning means are formed on the damping element so that, when the flexibly supported aligning means deflects, the detent foot is prevented from engaging in the module mounting, especially in at least one detent aperture of the module mounting. If the aligning means does not engage or only partly engages in one of the corresponding apertures of the inflator or of the module mounting, a deflection of the aligning means is given. Consequently, such deflection advantageously prevents the correct interconnection of the three components.

Only when the aligning means engages in the corresponding through-holes of the inflator and of the module mounting, is no deflection of the aligning means given. Then it is possible to positively connect the inflator to the damping element and to positively connect the damping element to the module mounting by the at least one detent foot of the damping element engaging in the at least one detent aperture of the module mounting.

### BRIEF DESCRIPTION OF THE DRAWINGS

Hereinafter the invention will be illustrated in detail by way of an embodiment with reference to the enclosed schematic drawings. The FIGS. 1 to 4 show different perspective views of an airbag unit according to the invention in accordance with a preferred embodiment and, respectively, of the pertinent components.

There is schematically shown in:

FIG. 1: a perspective view of a damping element of the airbag unit according to the invention in accordance with a preferred embodiment;

FIG. 2: a detailed view of aligning means of the damping element according to FIG. 1;

FIG. 3: a perspective view of an inflator including the damping element according to FIG. 1; and

FIG. 4: a rear view of an airbag unit according to the invention in accordance with a preferred embodiment including a module mounting and the inflator according to FIG. 3.

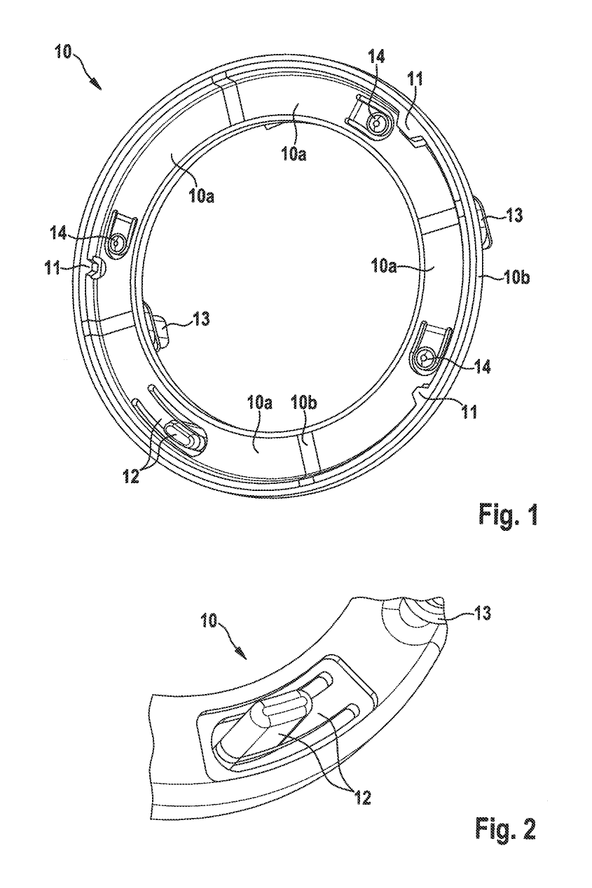

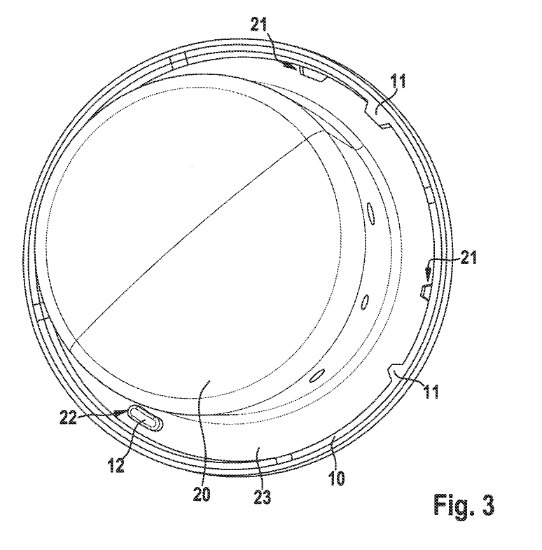

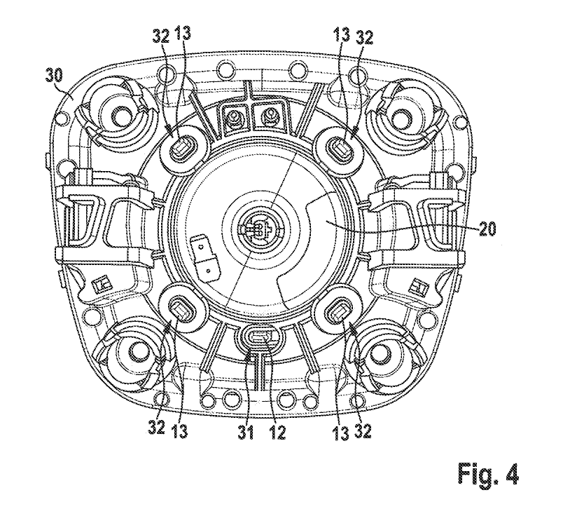

### DESCRIPTION

FIG. 1 illustrates an embodiment of a damping element 10 of the airbag unit. The annular damping element 10 includes a bearing face 15 and an outer collar 16. On the inside of the collar 16 three engaging means 11 being offset from the bearing face 15 are provided. According to FIG. 1, each of the engaging means 11 takes a trapezoidal geometry and is arranged along the collar 16. The rim sides are flattened at an angle of about 45° in mirror symmetry relative to each other. One of the engaging means 11 has a larger width than the other two engaging means 11, which results in an unambiguous alignment of the damping means 10. The other two engaging means 11 take an identical shape. Furthermore the engaging means 11 are arranged to be radially offset relative to each other by about 60° along the inside of the collar 16.

Along the bearing face 15 of the damping element 10 three tensioning elements 14 and one aligning means 12 are arranged to be offset by 45° relative to each other. The aligning means 12 is formed on the bearing face 15 by a U-shaped through-hole or through-groove penetrating the damping element 10. The aligning means 12 includes a web having a lug at the free-swinging end thereof. The lug extends starting from the bearing face 15 in both directions and has an oval basic shape. Through the U-shaped through-hole the web of the aligning means 12 forms a beam supported on one side that enables the resilient and flexible support of the lug.

The three tensioning elements 14 are equally formed on the bearing face 15 with the aid of U-shaped through-holes. On the free-swinging rounded end of the respective web a spherical portion projecting from the bearing face 15 is provided. The spherical portions have a diameter corresponding to the width of the web. The three tensioning elements 14 are identical according to FIG. 1. Further, each of the tensioning elements 14 is arranged in direct vicinity of one of the engaging means 11. Accordingly, the aligning means 12 is provided separately at a circular portion of the annular damping element 10, while the engaging means 11 and the tensioning elements 14 are arranged in respective pairs along the residual circumference of the damping element 10.

The embodiment of the damping element 10 shown in FIG. 1 is composed of a first part 10a on the inflator side and a second part 10b on the module mounting side. The first part 10a of the damping element 10 is divided into four equally sized segments of circle. On each of the circle segments of the first part 10a the three engaging means 11 and the three tensioning means 14 are arranged in pairs, as described before, while the aligning means 12 is arranged separately on one of the circle segments.

The second part 10b of the damping element 10 includes material recesses or grooves, respectively, so as to receive the four circle segments of the first part 10a of the damping element 10. The material recesses in the second part 10b are formed so that separation webs of the second part 10b are provided between the inserted circle segments of the first part 10a. The L-shaped cross-sectional geometry of the first part 10a in the assembled state according to FIG. 1 terminates flush with the second part 10b, the first part 10a being supported on the inner diameter of the bearing face 15 by the second part 10b.

Furthermore, the second part 10b of the damping element 10 includes through-holes along the tensioning elements 14 and the aligning means 12 so as to allow flexible and resilient support thereof. Further, through-holes opposed to the engaging means 11 are provided which extend through the bearing face 15 of the first part 10a and through the second part 10b.

The second part 10b of the damping element 10 includes a surface on the module mounting side facing away from the first part 10a of the damping element 10. According to FIG. 1, four detent feet 13 are provided on said module mounting side surface. Said detent feet are arranged to face the separation webs of the second part 10b which delimit the four circle segments of the first part 10a of the damping element 10 relative to each other. The lugs 13 are basically configured to take an oval basic shape. Along the height direction the detent feet 13 have a varying cross-section including at least one tapering so that the detent feet 13 can be positively locked with a module mounting 30.

The first part 10a of the damping element 10 may comprise a different material than the second part 10b. By selecting an appropriate material the rigidities of the flexibly and, resp., resiliently supported tensioning elements 14 and of the aligning means 12 can be adjusted. According to FIG. 1 the elements and through-holes are preferably provided to follow, as to their extension, the radial course of the annular damping element 10. It is further possible to configure the basic geometric shapes of the engaging means 11, the tensioning means 14, the aligning means 12 and the detent feet 13 other than illustrated in FIG. 1, if the function of the respective element is maintained.

1-10. (canceled)

11. An airbag unit comprising at least one damping element (10), an inflator (20) and a module mounting (30), the damping element (10) being interposed between the inflator (20) and the module mounting (30),
wherein the at least one damping element (10) includes at least one engaging means (11) and the inflator (20) includes at least one receiving means (21) so that the damping element (10) and the inflator (20) are positively connectable to each other, in the form of a bayonet lock.

12. The airbag unit according to claim 11, wherein the damping element (10) includes at least one aligning means (12) through which the inflator (20) and the module mounting (30) can be aligned relative to each other.

13. The airbag unit according to claim 11, wherein the aligning means (12) includes an extension on the module mounting side and an extension on the damping element side and/or the aligning means (12) is flexibly and,
respectively, resiliently supported in the direction of the module mounting side and in the direction of the inflator side.

14. The airbag unit according to claim 11, wherein a through-hole (22), in a form corresponding to the aligning means (12), for receiving the aligning means (12) is formed on the inflator (20).

15. The airbag unit according to claim 14, wherein the through-hole (22) is formed on the rim of the inflator (20).

16. The airbag unit according to claim 14, wherein a through-hole (31), in a form corresponding to the aligning means (12), for receiving the aligning means (12) is formed on the module mounting (30).

17. The airbag unit according to claim 11, wherein the damping element (10) is an annular damping element having a preferably L-shaped cross-section, and/or the engaging means (11) is arranged on an inside of the damping element (10), and wherein the engaging means (11) is configured as at least one material projection.

18. The airbag unit according to claim 17, wherein the engaging means (11) is arranged on an inner diameter of the damping element (10).

19. The airbag unit according to claim 11, wherein the inflator (20) includes a receiving means (21) which is formed on a rim of the inflator (20) as at least one material cutout, in a form corresponding to the engaging means (11).

20. The airbag unit according to claim 19, wherein the at least one material cutout is in a form corresponding to the engaging means (11).

21. The airbag unit according to claim 11, wherein at least one detent foot (13) is formed on the damping element (10) such that, when the aligning means (12) engages in the material cutout (31) of the module mounting (30), the damping element (10) can be connected to the module mounting (30) via the at least one detent foot (13), especially by locking in place in a corresponding detent aperture (32) of the module mounting (30).

22. The airbag unit according to claim 21, wherein the damping element (10) can be connected to the module mounting (30) by locking in place in a corresponding detent aperture (32) of the module mounting (30).

23. A vehicle occupant safety system comprising a steering wheel and an airbag unit according to claim 11, wherein the airbag unit is connectable or connected to the steering wheel and includes a cap covering the airbag at least on the occupant side.

24. A method of manufacturing an airbag unit according to claim 11, comprising, upon engagement of the damping element (10) by the engaging means (11) in the receiving means (21) of the inflator (20), twisting the damping element (10) and the inflator (20) are against each other along a joint axis of rotation so that a positive connection, in the form of a bayonet lock, is provided.

25. The method of manufacturing an airbag unit, according to claim 24, arranging the flexibly supported aligning means on the damping element (10) and arranging the respective at least one corresponding through-holes (22, 31) on the inflator (20) and the module mounting (30) so that the inflator (20) and the module mounting (30) are positioned relative to each other upon engagement of the aligning means (12) in the through-holes (22, 31), wherein the at least one detent foot (13) and the aligning means (12) are formed on the damping element (10) such that, when the flexibly supported aligning means (12) deflects, the detent foot (13) is prevented from locking in the module mounting (30).
